(19) United States
(12) Patent Application Publication
(10) Pub. No.: US 2026/0170744 A1
(43) Pub. Date: Jun. 18, 2026

(54) SYSTEMS AND METHODS FOR FRAME PROCESSING IN A DISPLAY DEVICE DURING A SCROLL EVENT

(71) Applicant: SAMSUNG ELECTRONICS CO., LTD., Suwon-si (KR)

(72) Inventors: Sripurna MUTALIK, Bangalore (IN); Anuradha Kanukotla, Bangalore (IN); Sethu Mathavan B, Bangalore (IN)

(73) Assignee: SAMSUNG ELECTRONICS CO., LTD., Suwon-si (KR)

(21) Appl. No.: 19/534,154

(22) Filed: Feb. 9, 2026

Related U.S. Application Data
(63) Continuation of application No. PCT/KR2024/011624, filed on Aug. 6, 2024.

(30) Foreign Application Priority Data
Aug. 10, 2023 (IN) 202341053810
Jul. 11, 2024 (IN) 202341053810

(51) Int. Cl. G06T 13/80; G06F 3/0485; G06F 3/0488

(52) U.S. Cl. CPC G06T 13/80; G06F 3/0485; G06F 3/0488; G06T 2200/24

(57) ABSTRACT

A method for frame processing in a display device during a scroll event is provided. The method includes determining a first processing time for generation of a first frame among a plurality of frames to be displayed on the display device; detecting an ongoing delay in the first processing time for the first frame based on a predefined frame duration threshold; determining whether a second frame is to be rendered on the display device subsequent to the ongoing delay based on one or more device parameters associated with the display device; and generating the second frame during the ongoing delay based on the determination that the second frame is to be rendered on the display device.

### CROSS-REFERENCE TO RELATED APPLICATION(S)

This application is a bypass continuation application of International Patent Application No. PCT/KR 2024/011624, filed on Aug. 6, 2024, which claims priority to Indian Patent Application No. 202341053810, filed on Jul. 11, 2024, which claims priority to Indian Provisional Applicant No. 202341053810, filed on Aug. 10, 2023, the disclosures of which are incorporated herein by reference in their entireties.

### BACKGROUND

### 1. Field

Embodiments of the present disclosure relate to display devices and more particularly, relate to systems and methods for frame processing in a display device during a scroll event.

### 2. Description of Related Art

Graphical user interfaces (GUIs) simplify end-user interaction with touchscreen display devices such as smartphones, tablets, touch laptops, etc. Scrolling can be used extensively in GUIs. For example, a person may spend approximately 108 minutes a day scrolling. Also, a person may scroll approximately 23 centimeters (cm) every five seconds. The person's thumb/finger may travel approximately 388.8 m per day.

Therefore, scroll performance may affect overall user experience with touchscreen display devices. However, scrolling may become janky when an application fails to completely draw and/or produce a frame in a synchronized manner.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to an aspect of one or more embodiments of the present disclosure, a method for or frame processing in a display device during a scroll event may include determining a first processing time for generation of a first frame among a plurality of frames to be displayed on the display device; detecting an ongoing delay in the first processing time for the first frame based on a predefined frame duration threshold; determining whether a second frame is to be rendered on the display device subsequent to the ongoing delay based on one or more device parameters associated with the display device; and generating the second frame during the ongoing delay based on the determination that the second frame is to be rendered on the display device.

The method may further include updating a buffer with the generated second frame.

The method may further include prior to the generating of the second frame, receiving an animation timeline depicting a display sequence of the plurality of frames; determining a number of one or more buffer frames to be displayed on the display device; identifying a frame duration of the first frame; determining a refresh time stamp of the display device based on a refresh rate of the display device; and updating the animation timeline by adding a new bias time based on the second frame and the determined refresh time stamp.

The method may further include rendering the generated second frame on the display device subsequent to the ongoing delay based on the updated animation timeline.

The method of rendering of the generated second frame on the display device may include identifying a scroll distance based on the identified refresh time stamp with the added bias time; and performing a scroll animation of the generated second frame based on the identified scroll distance.

The method may further include determining one or more vacant spaces within a buffer based on the generation of the second frame, wherein the buffer includes one or more frames to be rendered on the display device; generating one or more additional frames based on the one or more device parameters; and updating the buffer with the one or more additional frames.

The method of determining of the first processing time for generation of the first frame may be based on one or more frame-related parameters, the one or more frame-related parameters comprising refresh interval, view creation timing, view data binding timing, thread sleep timing, or a texture upload time.

The method of generating of the second frame may include triggering an instruction signal to an application to generate the second frame based on the scroll event.

The one or more device parameters may include a battery level, a power saving mode configuration, a current display refresh rate, motion smoothness, multiwindow mode, device temperature, or an available memory of the display device.

According to another aspect of one or more embodiments of the present disclosure, a system for frame processing in a display device during a scroll event may include memory storing at least one instruction; and at least one processor. The at least one instruction, when executed by the at least one processor individually or collectively, may cause the system to: determine a first processing time for generation of a first frame among a plurality of frames to be displayed on the display device; detect an ongoing delay in the first processing time for the first frame based on a predefined frame duration threshold; determine whether a second frame is to be rendered subsequent to the ongoing delay on the display device based on one or more device parameters associated with the display device; and generate the second frame during the ongoing delay based on the determination that the second frame is to be rendered.

The at least one instruction, when executed by the at least one processor individually or collectively, may cause the system to update a buffer with the second frame to be rendered on the display device subsequent to the ongoing delay based on the generation of the second frame.

The at least one instruction, when executed by the at least one processor individually or collectively, may cause the system to prior to the generation of the second frame, receive an animation timeline depicting a display sequence of the plurality of frames; determine a number of one or more buffer frames to be displayed on the display device; identify a frame duration of the first frame; determine a refresh time stamp of the display device based on a refresh rate of the display device; and update the animation timeline by adding a new bias based on the second frame and the determined refresh time stamp.

The at least one instruction, when executed by the at least one processor individually or collectively, may cause the system to: render the generated second frame on the display device subsequent to the ongoing delay based on the updated animation timeline.

The at least one instruction to render the generated second frame on the display device subsequent to the ongoing delay, when executed by the at least one processor individually or collectively, may further cause the system to: identify a scroll distance based on the identified refresh time stamp with the added bias time; and perform a scroll animation of the generated second frame based on the identified scroll distance.

According to another aspect of one or more embodiments of the present disclosure, a non-transitory computer-readable storage medium having stored thereon instructions that, when executed by at least one processor of a system individually or collectively, may cause the system to identify an detected touch input in a display device as a scroll event; determine a first processing time for generation of a first frame among a plurality of frames to be displayed on the display device; detect an ongoing delay in the first processing time for the first frame based on a predefined frame duration threshold; determine whether a second frame is to be rendered subsequent to the ongoing delay on the display device based on one or more device parameters associated with the display device; and generate the second frame during the ongoing delay based on the determination that the second frame is to be rendered.

The instructions may further comprise instructions that, when executed by the at least one processor individually or collectively, may cause the system to: update a buffer, with the second frame to be rendered on the display device subsequent to the ongoing delay based on the generation of the second frame.

The instructions may further comprise instructions that, when executed by the at least one processor individually or collectively, may cause the system to: prior to the generation of the second frame, receive an animation timeline depicting a display sequence of the plurality of frames; determine a number of one or more buffer frames to be displayed on the display device; identify a frame duration of the first frame; determine a refresh time stamp of the display device based on a refresh rate of the display device; and update the animation timeline by adding a new bias based on the second frame and the determined refresh time stamp.

The instructions may further comprise instructions that, when executed by the at least one processor individually or collectively, may cause the system to: render the generated second frame on the display device subsequent to the ongoing delay based on the updated animation timeline.

The instructions to render the generated second frame on the display device subsequent to the ongoing delay further comprise instructions that, when executed by the at least one processor individually or collectively, cause the system to: identify a scroll distance based on the identified refresh time stamp with the added bias time; and perform a scroll animation of the generated second frame based on the identified scroll distance.

The one or more device parameters may include a battery level, a power saving mode configuration, a current display refresh rate, motion smoothness, multiwindow mode, device temperature, or an available memory of the display device.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1A illustrates an example frame rendering and timeline flow;

FIG. 1B illustrates an example base frame chart depicting the occurrence of janking;

FIG. 2 illustrates a system environment for frame processing in a display device during a scroll event, according to an embodiment of the present disclosure;

FIG. 3 illustrates a flowchart for a method for frame processing management for the display device, according to an embodiment of the present disclosure;

FIG. 4 illustrates a flowchart for a method for updating an animation timeline for the display device, according to an embodiment of the present disclosure;

FIG. 5 illustrates a flowchart for an exemplary method for frame processing in the display device during a scroll event; according to an embodiment of the present disclosure;

FIG. 6 illustrates an exemplary scenario of a process of frame buffering in the display device, according to an embodiment of the present disclosure;

FIG. 7 illustrates an exemplary sequence flow for scroll event detection and frame management, according to an embodiment of the present disclosure;

FIG. 8 illustrates a frame chart corresponding to frame rendering at the display device, according to an embodiment of the present disclosure;

FIG. 9 illustrates a frame-by-frame comparison of the scroll performance of the display device, in accordance with an embodiment of the present disclosure; and

FIG. 10 illustrates exemplary use-case scenarios of reduced frame drop, in accordance with an embodiment of the present disclosure.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more elements is required.”

It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to,” or “directly coupled to” another element or layer, there are no intervening elements or layers present.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Use of terms such as “a” and “an” and “the” and similar referents in context of describing disclosed embodiments (especially in context of following claims) are to be construed to cover both singular and plural, unless otherwise indicated herein or clearly contradicted by context, and not as a definition of a term. Number of items in a plurality is at least two, but can be more when so indicated either explicitly or by context.

Terms such as “comprising,” “having,” “including,” and “containing” are to be construed as open-ended terms (meaning “including, but not limited to,”) unless otherwise noted. The terms may specify the presence of stated features, numbers, steps, operations, elements, components or combinations thereof. The terms may not preclude the possibility of the presence or addition of one or more other features, numbers, steps, operations, elements, components, and/or combinations thereof. Recitation of ranges of values herein are merely intended to serve as a shorthand method of referring individually to each separate value falling within range, unless otherwise indicated herein and each separate value is incorporated into one or more embodiments of the present disclosure as if it were individually recited herein. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Conjunctive language, such as phrases of form “at least one of A, B, and C,” or “at least one of A, B or C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items).

Further, unless stated otherwise or otherwise clear from context, phrase “based on” means “based at least in part on” and not “based solely on.”

Embodiments of the present disclosure may relate to the stacking of the application buffer for a smooth scroll experience. Specifically, embodiments of the present disclosure may relate to techniques for improving user scrolling experience. More specifically, embodiments of the present disclosure may include injecting a new frame from an application by scheduling a draw call on the application's main thread whenever the current frame is janky. Thus, embodiments of the present disclosure may further include allowing a system framework component to have more buffers to display in case of consecutive frame drops. The embodiments of the present disclosure may include detecting an ongoing delay in the processing time (generation and/or rendering) for a first frame using the current Vsync interval, view creation timing, view data binding timing, thread sleep timing, texture upload, and buffer Transceiver (TX) count. The embodiments of the present disclosure may further include detecting an ongoing delay in the processing time (generation and/or rendering) for the N^{th} frame using the current Vsync interval, view creation timing, view data binding timing, thread sleep timing, texture upload, and buffer TX count. The embodiments of the present disclosure may further include initiating processing for generation and/or rendering of the N+1^{st} frame during the ongoing N^{th} frame generation time. The embodiments of the present disclosure may further include enqueueing the buffer for displaying the frame in an immediate rendering interval to avoid frame drop due to the N^{th} frame. The embodiments of the present disclosure may include computing an animation timeline for determining a position to render one or more generated frames on the display device during the ongoing delay.

The embodiments of the present disclosure may further include generating future frames according to the Buffer Queue count within the SurfaceFlinger (i.e., the component of an operation system of the user device that is configured to compose and display the frame on the device display). Further, embodiments of the present disclosure may include rendering the Application UI content at the Vsync interval. The embodiments of the present disclosure may include rescheduling a callback to execute immediately after a scroll input has crossed a slop threshold, thus the techniques do not affect the Vsync interval.

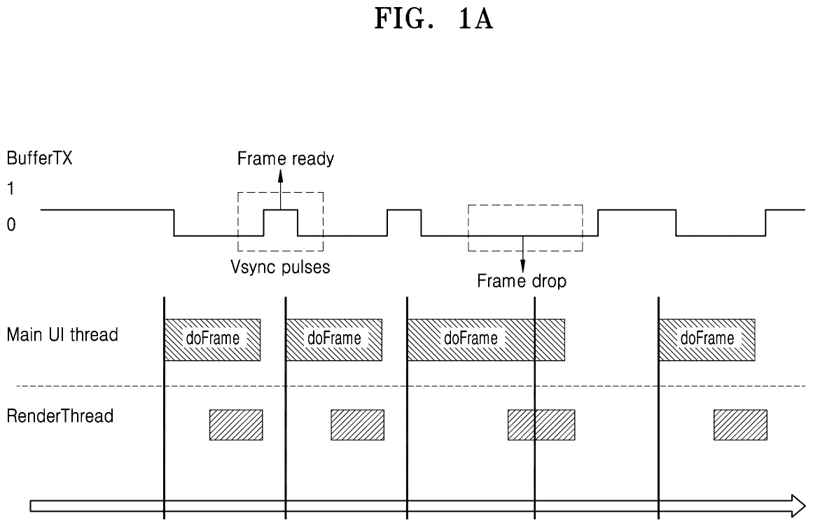

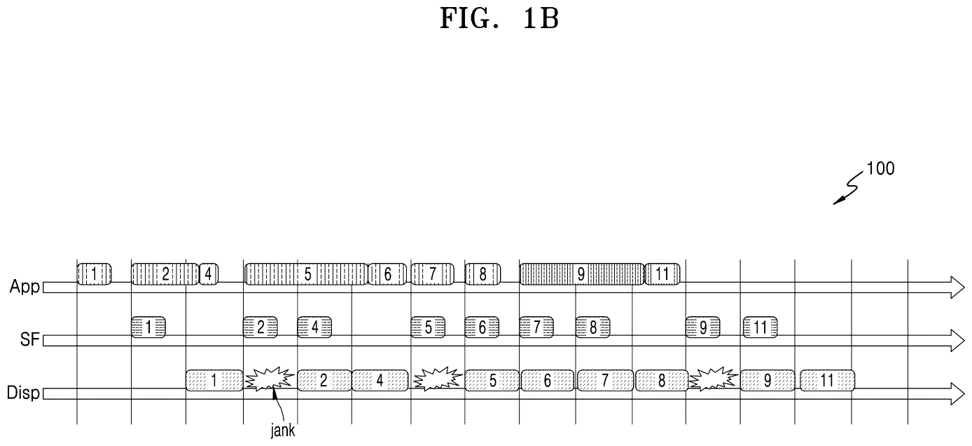

FIG. 1A illustrates frame rendering and timeline flow in an Android® system. Delayed response and/or janky scrolling of the display device may be explained with reference to the illustrated scroll flow. FIG. 1A illustrates a user interface (UI) thread that is one of a main thread in applications running over the Android® system. Further, the UI thread may also issue the drawing commands to a RenderThread for each frame using a function called a doFrame. The RenderThread may also be responsible for running the drawing commands issued by the main UI thread on a Graphics Processing Unit (GPU). A Vsync signal/pulse may be utilized for synchronization of a display timeline. Further, a frame completion time may be defined as the time between a start of the doFrame function and an end of the GPU completion. Thus, the frame completion time may be less than an interval between the consecutive Vsync signal/pulse. Further, a Buffer TX may refer to a count of the number of buffers that are sent by the application to a SurfaceFlinger (a frame composer) and are ready to be composed by the SurfaceFlinger. The SurfaceFlinger which is one of the most essential components of the Android® system may be configured to accept buffers of data from multiple sources, compose, and send the data to the display. Thus, the SurfaceFlinger may pick one buffer for composition before showing it on display. In case there are no buffers available, there may be a frame drop leading to a user-visible jank. Also, if there is a big doFrame function, the SurfaceFlinger may consume all the buffers before it finishes, which leads to a frame drop when it wants the next buffer.

FIG. 1B illustrates a base frame chart 100 depicting an occurrence of janking. The base frame chart 100 disclosed herein may be used to methodically illustrate the janking of the drawn frames. The base frame chart 100 may illustrate a plurality of frames that are first drawn by an application in a Vsync pulse. The plurality of frames pulled by the application may be further composed by the SurfaceFlinger (SF) in another Vsync pulse. The frame composed by the SF may be displayed on a User Interface (UI) of the display device on yet another Vsync pulse. However, when a frame 2 in the Vsync pulse of the application takes more than a predefined time to draw and the composition from the SF does not happen as is intended. Since the frame 2 cannot be drawn on time, the SF may signal a jank. Similarly, FIG. 1B illustrates a frame 5, which may take longer to render the respective frame, which further causes the SF composition to be missed. Due to the missed SF composition, after a frame 4, the UI may not have the frame 5 at the correct Vsync pulse, leading to the signaling of a jank.

Specifically, in a scroll scenario, an application UI rendered frame count may become 0 when a big rendering block occurs as no new buffers are produced at that time, and as the SurfaceFlinger may consume one buffer for each Vsync pulse, this leads to janking.

Therefore, in view of the above-mentioned problems, it is advantageous to provide an improved system and method that can overcome the above-mentioned problems and limitations.

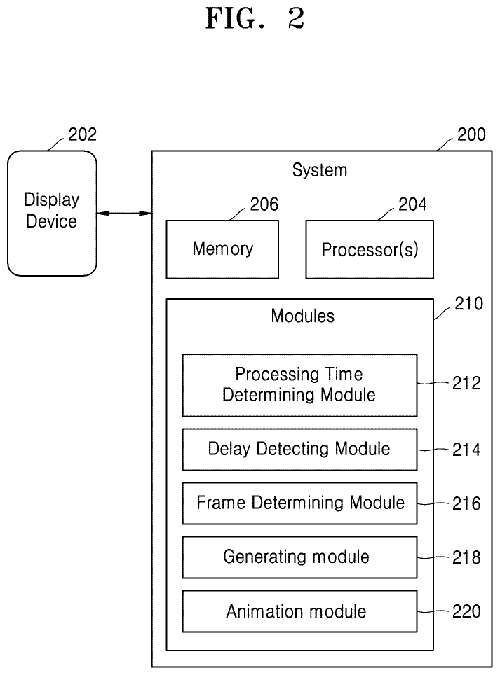

FIG. 2 illustrates a system environment for frame processing in a display device 202 during a scroll event, according to an embodiment of the present disclosure. In an exemplary embodiment, the display device 202 may correspond to any suitable touch screen display device such as, but not limited to, a smartphone, a tablet, a touch laptop, smartwatches, interactive kiosks, etc. The display device 202 may be connected to a system 200 configured to perform the frame processing in the display device 202. In one embodiment, the system 200 may be implemented within the display device 202. In another embodiment, the system 200 may be implemented as a standalone unit communicably coupled with the display device 202 via any suitable network system.

The system 200 may include a memory 206, one or more processors 204 (hereafter referred to as the processor 204), and one or more modules 210.

In an exemplary embodiment, the processor 204 may be operatively coupled to each of the memory 206, and the modules 210. In one embodiment, the processor 204 may include at least one data processor for executing processes in Virtual Storage Area Network. The processor 204 may include multiple processors. The processor 204 may include specialized processing units such as, integrated system (bus) controllers, memory management control units, floating point units, graphics processing units (GPU)s, digital signal processors (DSPs), etc. In one embodiment, the processor 204 may include a Central Processing Unit (CPU), a Graphics Processing Unit (GPU), or both. The processor 204 may be one or more general processors, Digital Signal Processors (DSPs), application-specific integrated circuits, Field-Programmable Gate Arrays (FPGAs), servers, networks, digital circuits, analog circuits, combinations thereof, or other now-known or later developed devices for analyzing and processing data. The processor 204 may execute a software program, such as code generated manually (e.g., programmed) to perform the desired operation. The processor 204 may implement various techniques such as, but not limited to, image processing, data extraction, Artificial Intelligence (AI), Machine Learning (ML), Deep Learning (DL) and so forth to achieve the desired objective.

In an embodiment, the processor 204 may be configured to generate and display a plurality of frames on the display device 202. In one embodiment, the plurality of frames may correspond to one or more applications installed within the display device 202. The processor 202 may be configured to improve the scroll performance of the display device 202.

Particularly, the processor 204 may be configured to determine a first processing time for generation of a first frame among the plurality of frames to be displayed on the display device 202. The processor 204 may determine the first processing time based on one or more frame-related parameters. Such frame-related parameters may include, but are not limited to, refresh interval, view creation timing, view data binding timing, thread sleep timing, and a texture upload time. Thereafter, the processor 204 may be configured to detect an ongoing delay in the first processing time for the first frame based at least on a predefined Frame Duration Threshold (FDT). For instance, the processor 204 may determine whether the first processing time is greater than the predefined FDT to detect the ongoing delay. The predefined FDT may be pre-stored in the memory 206 and/or pre-determined by the processor 204. In an embodiment, the processor 204 may determine the predefined FDT based on one or more device parameters. In one embodiment, the predefined FDT may be determined based on the following Equation 1:

$$Threshold ( FDT ) = w 1 p 1 + w 2 p 2 + w 3 p 3 + … + w n \{ p n \} / w 1 + w 2 + w 3 + … + w n$$

Here, p1-pn may correspond to one or more device parameters. Examples of the one or more device parameters may include, but are not limited to, a battery level, a power saving mode configuration, a current display refresh rate, motion smoothness, multiwindow mode, device temperature, and an available memory of the display device 202.

In some embodiments, w1-wn may corresponds to one or more weight values of the corresponding device parameters p1-pn.

In some embodiments, the processor 204 may detect the ongoing delay when the first processing time is greater than the predefined FDT.

The processor 204 may then determine whether a second frame is required for rendering on the display device 202 based on the detected ongoing delay and the one or more device parameters associated with the display device 202. Particularly, based on the predefined FDT, the processor 204 may classify the current frame and/or the first frame as janky or non-janky. In case the processor 204 classifies that the current frame and/or the first frame is janky, the processor 204 may determine that a next frame and/or the second frame is required for rendering on the display device 202.

In some embodiments, the processor 204 may determine that a next frame and/or the second frame is required for rendering on the display device 202 when the ongoing delay is detected.

Further, upon determining that the second and/or the next frame is required, the processor 204 may be configured to initiate generation of the one or more second frames and/or next frames during the ongoing delay.

In some embodiments, upon determining that the second and/or the next frame is required, the processor 204 may be configured to instruct the corresponding application to schedule “draw frames” operations until the frame buffer queue is full. Particularly, the processor 204 may request the application to extract more frames to avoid such janking in subsequent frame rendering. The processor 204 may be configured to update a buffer with the second frame for rendering on the display device subsequent to the ongoing delay. The buffer may be stored in the memory 206 and may include the plurality of frames to be displayed on the display device 202.

In some embodiments, the processor 204 may be configured to receive an animation timeline depicting a display sequence of the plurality of frames. The animation timeline may define exactly when and where each frame will appear during a scrolling motion to create smooth visual movement. The processor 204 may then be configured to determine a number of one or more buffer frames to be displayed on the display device. The processor 204 may also be configured to identify a frame duration of the first frame and/or the current frame. Thereafter, the processor 204 may determine a refresh time stamp of the display device 204 based on a refresh rate of the display device 204. The refresh time stamp may refer to a timing marker that indicates the exact moment when the display hardware will be ready to show the next frame, calculated based on the device's refresh rate. Then, the processor 204 may update the animation timeline by adding a bias on the second frame and the determined refresh time stamp. Lastly, the processor 204 may be configured to render the generated second frame and/or the next frame on the display device 202 subsequent to the ongoing delay based on the updated animation timeline.

In some embodiments, the processor 204 may be configured to identify a scroll distance based on the identified refresh time stamp with added bias. Further, the processor 204 may be configured to perform a scroll animation of the generated one or more second frames and/or next frames based on the identified scroll distance. Moreover, the processor 204 may also be configured to determine one or more vacant spaces within the buffer. The processor 204 may be configured to generate one or more additional frames based on the detected ongoing delay and the one or more device parameters. Thereafter, the processor 204 may be configured to update the buffer with the one or more additional frames.

Alternatively, in case there is the first frame and/or the current frame is a non-janky frame, the processor 202 may continue to render subsequent frames according to a current display refresh timeline. Thus, the processor 204 may increase the maximum number of acquired buffers on a frame composer. Also, the processor 204 may compensate the animation timeline based on the existing buffers yet to be displayed and the generated buffer rounded off to the nearest display refresh interval.

In some embodiments, the memory 206 may be communicatively coupled to the at least one processor 204. The memory 206 may be configured to store data, instructions executable by the at least one processor 204. In one embodiment, the memory 206 may communicate via a bus within the system 200. The memory 206 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 206 may include a cache or random-access memory for the processor 204. In alternative examples, the memory 206 is separate from the processor 204, such as a cache memory of a processor, the system memory, or other memory. The memory 206 may be an external storage device or database for storing data. The memory 206 may be operable to store instructions executable by the processor 204. The functions, acts or tasks illustrated in the figures or described may be performed by the programmed processor 204 for executing the instructions stored in the memory 206. The functions, acts or tasks are independent of the particular type of instructions set, storage media, processor or processing strategy and may be performed by software, hardware, integrated circuits, firmware, micro-code, and the like, operating alone or in combination. Likewise, processing strategies may include multiprocessing, multitasking, parallel processing, and the like. The memory 206 may further include a database to store the data. Further, the memory 206 may include an operating system for performing one or more tasks of the system 200, as performed by a generic operating system in the communications domain.

The modules 210, amongst other things, include routines, programs, objects, components, data structures, etc., which perform particular tasks or implement data types. The modules 210 may also be implemented as, signal processor(s), state machine(s), logic circuitries, and/or any other device or component that manipulates signals based on operational instructions.

Further, the modules 210 can be implemented in hardware, instructions executed by a processing unit, or by a combination thereof. The processing unit may comprise a computer, the processor 204, a state machine, a logic array, or any other suitable devices capable of processing instructions. The processing unit may be a general-purpose processor that executes instructions to cause the general-purpose processor to perform the required tasks, or the processing unit can be dedicated to performing the required functions. In another embodiment of the present disclosure, the modules 210 may be machine-readable instructions (software) which, when executed by a processor/processing unit, perform any of the described functionalities. Furthermore, the data may serve, amongst other things, as a repository for storing data processed, received, and generated by one or more of the modules.

The modules 210 may be configured to perform one or more operations of the processor 204. In one example, the modules 210 may include a processing time determining module 212, a delay detecting module 214, a frame determining module 216, a generating module 218, and an animation module 218. Such modules may connected with each other.

In an embodiment, the processing time determining module 212 may be configured to determine a first processing time for generation of the first frame among the plurality of frames to be displayed on the display device 202. The delay detecting module 214 may be configured to detect the ongoing delay in the first processing time for the first frame based at least on the predefined FDT. The frame determining module 216 may be configured to determine whether the second frame is required for rendering on the display device 202 based on the detected ongoing delay and one or more device parameters associated with the display device 202. The generating module 218 may be configured to initiate generation of the one or more second frames during the ongoing delay upon determining that the second frame is required by the frame determining module 216. Moreover, the animation module 220 may be configured to update the animation timelines based on the generated one or more second frames, as discussed above.

The system 200 may perform various operations described herein. Further, the system 200 may include one or more additional components required to implement the desired functionality of the system 200 (e.g., to improve scroll event performance on the display device 202).

It should be noted that not all modules in the above structure diagrams are necessary, and some modules may be omitted according to actual requirements. The division of the various modules is only for the convenience of describing the functional division adopted. In actual implementations, one module may be implemented as multiple modules, and the functions of multiple modules may also be implemented by the same module. These modules may be located in the same device or in different devices.

Hardware modules in the various implementations may be implemented mechanically or electronically. For example, a hardware module may include a specially designed permanent circuit or logic device (e.g., a dedicated processor such as an FPGA or an ASIC) to perform a particular operation. The hardware module may also include a programmable logic device or circuit (e.g., including a general-purpose processor or other programmable processors) temporarily configured by software to perform a specific operation. The hardware modules can be implemented mechanically, with dedicated permanent circuits, or with temporarily configured circuits (e.g., software-configured), depending on cost and time considerations.

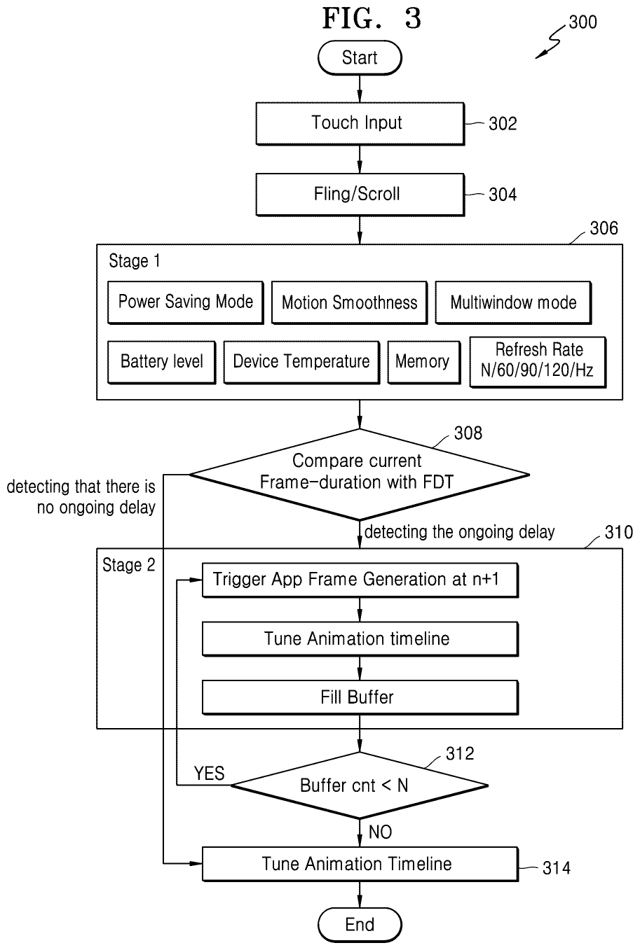

FIG. 3 illustrates a flowchart for a method 300 for frame processing management for the display device 202, according to an embodiment of the present disclosure. The method 300 may be performed by one or more components of the system 200.

In the following embodiments, operations may be performed sequentially, in a different order, in parallel, or with some operations skipped or repeated.

At operation 302, the method 300 may include detecting a touch input on the display device 202. In an embodiment, the display device 202 may include a touch-sensitive display configured to receive one or more user inputs via a user-touch. At operation 304, the method 300 may include identifying the detected touch input as a fling or a scroll event. The fling event may correspond to a quick and sudden swipe or flick movement by the user on the display device 202, and the scroll event may correspond to a slower or a controller movement of the UI on the display device 202 via the user touch movement. Thus, based on the gesture of user movement, the system 200 may identify the touch input as the fling or the scroll event.

Operation 306 may correspond to stage 1 of the frame processing management. Specifically, at stage 1, the system 200 may identify an FDT based on the device parameters including, but not limited to, the battery level, the power saving mode configuration, the current display refresh rate, the motion smoothness, the multiwindow mode, the device temperature, and the available memory of the display device 202, and so forth. The system 200 may also identify the current frame duration and/or processing time for the first/current frame. The current frame duration and/or processing time for the first/current frame may depend on factors such as, but not limited to, a current Vsync interval, view creation timing, view data binding timing, thread sleep timing, texture upload timing, and buffer TX count.

At operation 308, the system 200 may compare the current frame duration with the FDT to detect an ongoing delay in the processing of the current frame. Upon detecting the ongoing delay in the processing of the current frame, the system 200 may process to stage 2 referred by operation 310. However, upon detecting that there is no ongoing delay in the processing of the current frame, the method 300 may directly proceed to operation 314.

Specifically, at operation 310 or stage 2, the system 200 may initiate the generation of one or more second frames/subsequent frames during the ongoing delay if the second frame is absent. The system 200 may trigger a corresponding application to perform frame generation at time instance n+1 if the current frame corresponds to time instance n. Next, the system 200 may perform tuning the animation timeline. In particular, the system 200 may compute the animation timeline for determining a position to render the one or more generated second/subsequent frames on the display device 202 during the ongoing delay. After successfully computing the animation timeline, the system 200 may fill the buffer with the one or more generated second/subsequent frames.

At operation 312, the system 200 may determine whether the buffer count is still less than a predefined threshold value (N), and upon determining that the buffer count is less than the predefined threshold value (N), the system 200 may re-perform the stage 2 and/or operation 310.

Alternatively, in case the system 200, at operation 308, determines that there is no ongoing delay in the processing of the current/first frame and/or there are subsequent second/subsequent frames, the system 200 may directly tune the animation time 314 to effectively render the frames in the buffer.

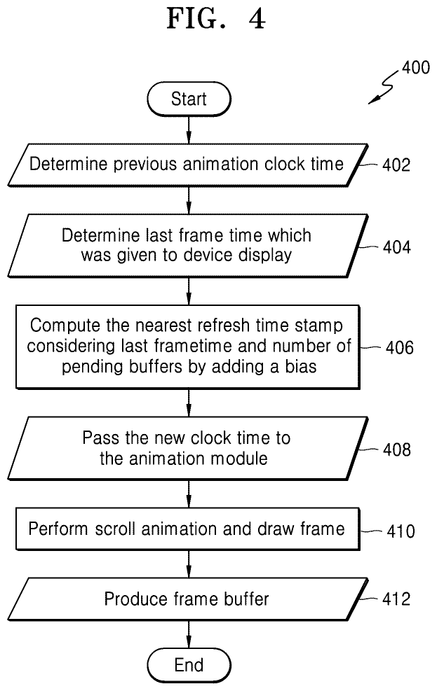

Moreover, the tuning of the animation timeline 314 will be further explained in reference to FIG. 4. Thus, the method 300 may enable the system 200 to instruct an application to enqueue the buffer for immediate display of the one or more second/subsequent frames after the first/current frame to avoid frame drop events. Moreover, the embodiments of the present disclosure may reduce user visible janks by increasing the number of UI buffers available through injection of a new application UI frame during the scroll event.

FIG. 4 illustrates a flowchart for a method 400 for updating an animation timeline for the display device 202, according to an embodiment of the present disclosure. The method 400 may be performed by one or more components of the system 200.

In the following embodiments, operations may be performed sequentially, in a different order, in parallel, or with some operations skipped or repeated.

At operation 402, the method 400 may include determining a previous animation clock time. Particularly, the system 200 may determine the previous animation clock time corresponding to the current application. The system 200 may determine the previous animation clock time based on previous usage of the current application by the user. In one embodiment, the animation clock time may correspond to the time taken to render each frame during an animation on the screen, such as during the scroll event. In an embodiment, the previous animation clock time may correspond to the timing of the Vsync signal or a display refresh rate pulse that triggered the previous animation.

At operation 404, the method 400 may include determining a last frame time which was given to the display device 202. For instance, the system 200 may identify the time taken by the last frame for processing.

At operation 406, the method 400 may include computing a nearest refresh time stamp considering the last frame time and the number of pending buffers. The system 200 may determine the nearest refresh time stamp considering the last frame time and number of pending buffers by adding a bias.

At operation 408, the method 400 may include passing the new clock time to the animation module 220 of the system 200. The animation module 220 may be configured to update the animation timelines based on the received new clock time.

At operation 410, the method 400 may include performing the scroll animation and retrieving the one or more second/subsequent frames based on the updated animation timeline.

At operation 412, the method 400 may include producing the frame buffer with the retrieved one or more second/subsequent frames and the updated animation timeline.

In one embodiment, the system 400 may be configured to trigger the application frame generation and tuning of animation timeline until the buffer is full.

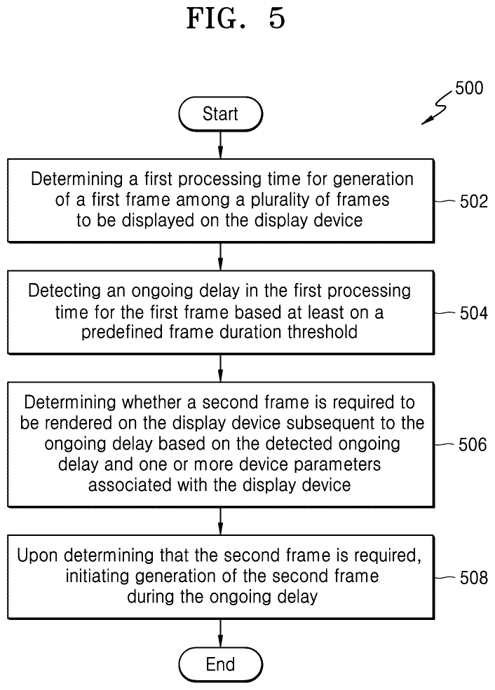

FIG. 5 illustrates a flowchart for an exemplary method 500 for frame processing in the display device 202 during a scroll event, according to an embodiment of the present disclosure. The method 500 may be performed by the one or more components of the system 200.

In the following embodiments, operations may be performed sequentially, in a different order, in parallel, or with some operations skipped or repeated

At operation 502, the method 500 may include determining the first processing time for generation of the first frame among the plurality of frames to be displayed on the display device 202.

At operation 504, the method 500 may include detecting an ongoing delay in the first processing time for the first frame based on a predefined frame duration threshold.

At operation 506, the method 500 may include determining whether a second frame is required to be rendered on the display device subsequent to the ongoing delay based on the detected ongoing delay and one or more device parameters associated with the display device 202.

At operation 508, the method 500 may include initiating generation of the second frame during the ongoing delay upon determining that the second frame is required.

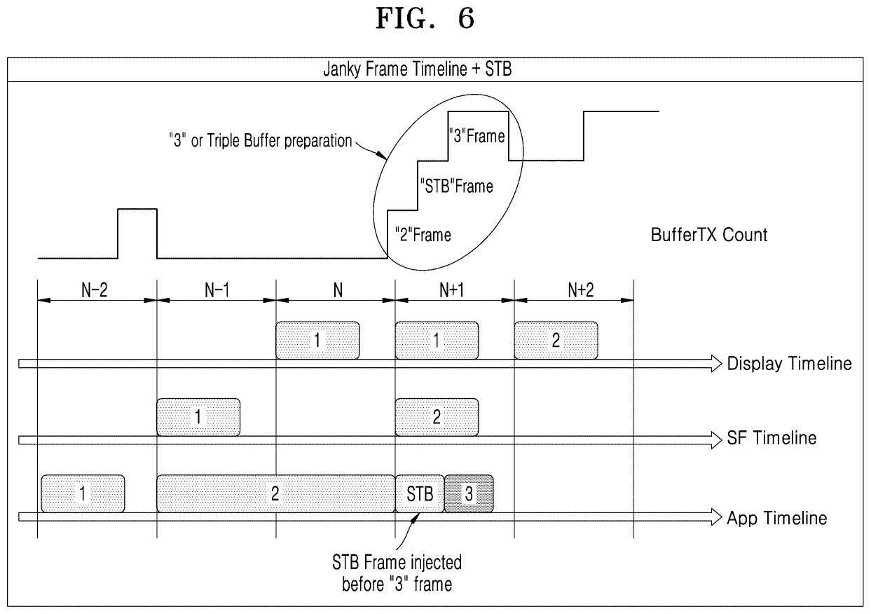

FIG. 6 illustrates an exemplary scenario of a process of frame buffering in the display device 202, according to an embodiment of the present disclosure. FIG. 6 illustrates three timelines namely, a display timeline, a SurfaceFlinger (SF) (also referred to as a frame composer) timeline, and an application timeline. Each of the three timelines may include a number of frames queued at different time instances. The jankiness in the frames may happen if there are no buffers available for the frame composer to consume and display at the Vsync interval, hence the same previous frame may be displayed for all Vsync events until the new frame is available. Thereafter, when a new frame (nth frame) is available, the user may feel a sudden jump in the UI from 1^{st} frame to n^{th} frame without any intermediate frames. For instance, when in the application timeline, frame 2 takes more than the expected frame processing time, the system 200 may draw a new frame (referred to as a Scroll Triple Buffering (STB) frame) before the next frame (i.e., frame 3) to remove any upcoming jankiness due to non-availability of a new frame in the frame buffer. Particularly, the system 200 may try to maintain at least three (Triple) buffers/frames at any instance of time and generate frames up to max buffers. This may provide a smoother transition among the frames during the scroll event and improves the overall user experience with the UI.

In an embodiment, the one or more modules 210 of the system 200 may be collectively referred to as an STB module that is specifically designed to minimize or prevent the jankiness that occurs while scrolling on any display device. The STB module may utilize a scroll detector that is configured to detect scrolls, flings, and also listen to the end of flings. Within the scope of fling detection and end-of-fling detection, the STB module may verify whether any rendering block has recycled reviews, texture uploads, or data binding blocks that have taken more than a predefined threshold time. If the rendering block requires more time than the predefined threshold time, a scheduling block may immediately schedule frame rendering. Due to the increased rendered frame count, when another rendering block is required in the future, the SF (or frame composer) may be pre-equipped with up to 3 buffers, which can be consumed until further frame rendering is completed.

In an embodiment, the STB module may be invoked after a comparison between a start time and an end time is made. The start time may be defined as when frame drawing starts, and the end time may be defined as when frame drawing ends in the respective User Interface (UI) thread. Further, the time for frame rendering (t) may be calculated as: t=end time −start time. Furthermore, whether the STB module will be invoked or not may depend on the s (e.g., being the factor used to determine whether the STB module will be invoked or not). Here, s may refer to a variable of binary nature, where s=1 may refer to a case when t>STB threshold, and s=0 may refer to another case scenario when t<=STB threshold.

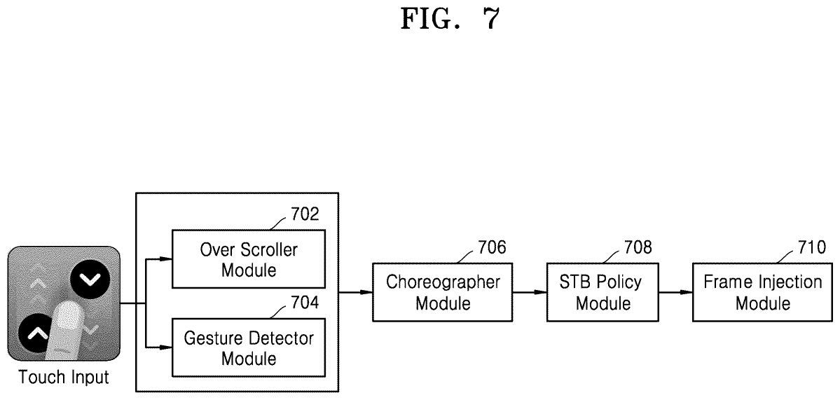

FIG. 7 illustrates an exemplary sequence flow for scroll event detection and frame management, according to an embodiment of the present disclosure. FIG. 7 illustrates an over scroller module 702, a gesture detector module 704, a choreographer module 706, a STB policy module 708, and a frame injection module 710. In one embodiment, the modules 702-710 may be part of the modules 210 of the system 200. In an exemplary embodiment, the over scroller module 702 and/or the gesture detector module 704 may be configured to monitor one or more user inputs on the display device 202 to detect a scroll or a fling event. The over scroller module 702 and/or the gesture detector module 704 may be configured to provide a callback for the detected scroll or fling event, respectively. Further, the choreographer module 706 may be notified at the start of the scroll or fling event. The choreographer module 706 may calculate the FDT based on display and device parameters, as discussed above. Further, the STP module 708 may be configured to compare a current frame timing with the FDT to determine whether to trigger the frame injection module 710 or not. Upon triggering the frame injection module 710, the frame injection module 710 may inject the one or more frames into the buffer queue of the SurfaceFlinger until the queue is full. This may prevent frame drop during the scroll or fling event and may provide a smoother user experience. Moreover, by tuning of the animation timeline, the system 200 may provide a unique frame during the scroll or the fling event and provide smooth scrolling.

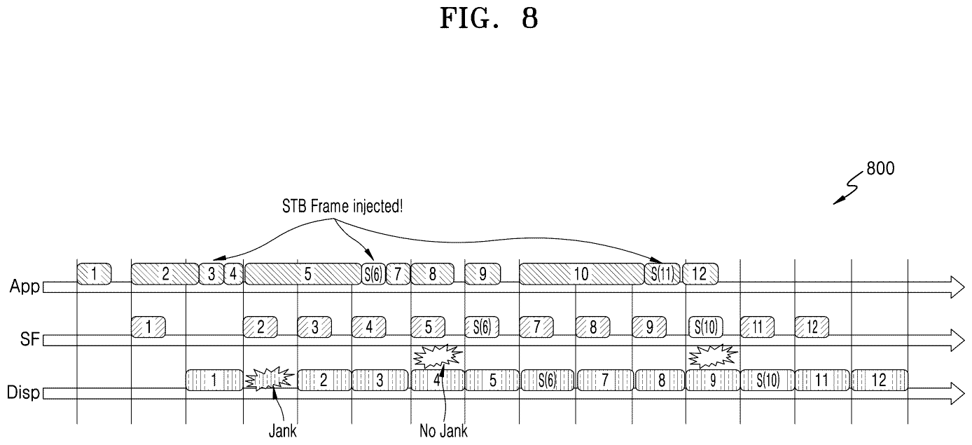

FIG. 8 illustrates a frame chart 800 corresponding to frame rendering at the display device 202, according to an embodiment of the present disclosure. The frame chart 800 illustrates the injection of the one or more frames, according to embodiments of the present disclosure. The frame chart 800 illustrates a plurality of frames that are first drawn by the application in a Vsync pulse. The plurality of frames pulled by the application may be further composed by the SurfaceFlinger (SF) in another Vsync pulse. The composed frame by SF may be displayed on the display of the display device on yet another Vsync pulse. With reference to FIG. 8, a frame 2 in the application Vsync pulse may take more than a predefined time to render, and hence STB frame 3 may be generated and injected for better and smoother functioning of the display device 202. This may have been indicated on the SF Vsync pulse and the display Vsync pulse. The generated frame 3 provides an adequate amount of buffer TX count, in order to remove jank which will be produced by the further frames.

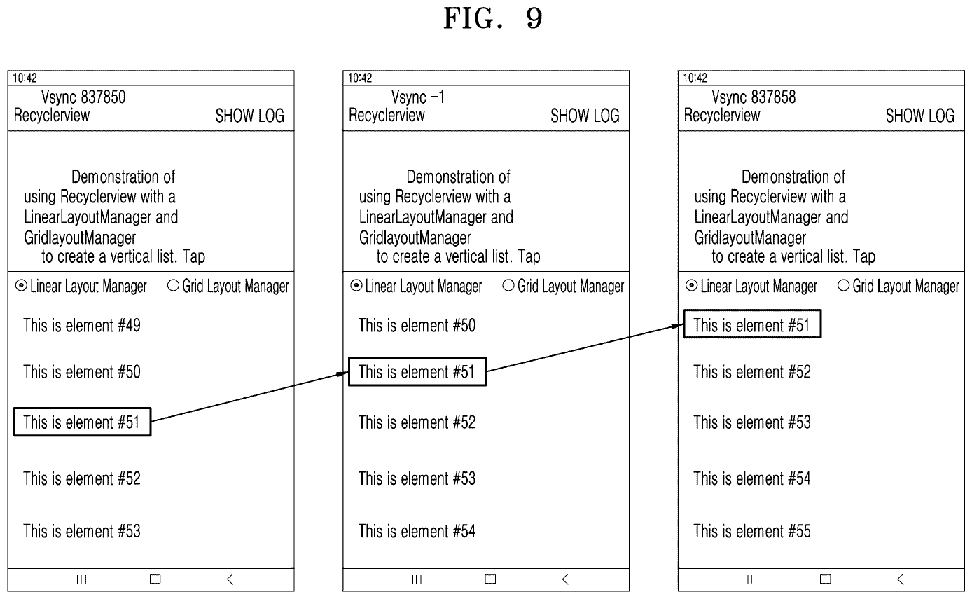

FIG. 9 illustrates a frame-by-frame comparison of the scroll performance of the display device, in accordance with an embodiment of the present disclosure. Disclosed herein is a progression of the scroll in an application with a scrollable view when the STB module has been invoked. A frame 837850 may correspond to a frame when the application utilizes a long-time draw. An STB frame −1 may be scheduled in order to overcome the jank and may be displayed immediately in the next Vsync pulse. Utilizing this opportunity, the frame 837858 may be drawn and displayed. FIG. 9 further indicates that the system 200 does not utilize duplication of frames and maintain the required speed of scroll. However, without performance of one or more operation described herein, the frame no-837850 may be displayed for 2 to 3 Vsync signals (60 HZ-48 ms, 120 HZ-24 ms) and may suddenly jump to frame no:837858 which may impact user experience.

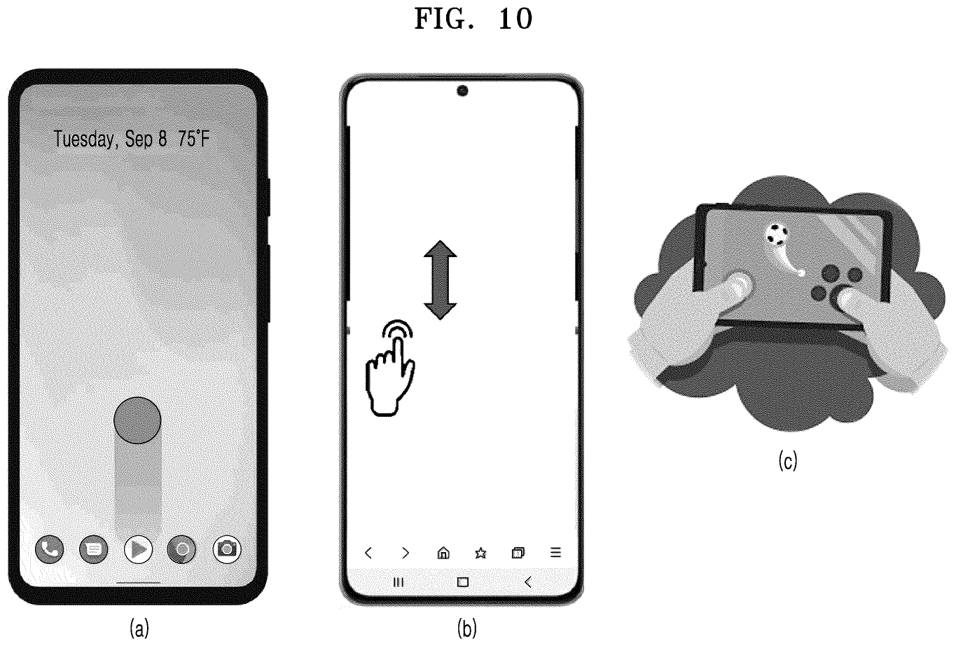

FIG. 10 illustrates exemplary use-case scenarios of reduced frame drop, in accordance with an embodiment of the present disclosure. Specifically, FIG. 10 illustrates the use of swipe gestures in order to assess the plurality of applications implanted on the display device by using the proposed solution. Such applications may include, but are not limited to, application GUI scrolling (a), web scrolling (b), and gaming (c).

A Variable Refresh Rate (VRR) may refer a display refresh rate that is adjusted based on application output frames. During a scroll scenario, some applications can use HINT to set refresh rates at different intervals (e.g., 120 Hz, 90 Hz, 60 Hz). Similarly, based on the system condition (e.g., power saving mode, user selection of standard/adaptive mode in motion smoothness, etc.) display refresh rate can be changed for all applications. To accommodate different display rates, the STB scheduler may define variable frame thresholds according to frame rates published by display hardware. Accordingly frames may be injected for a smooth scrolling experience in various refresh rates (e.g., . 120 Hz, 90 Hz, 60 Hz).

Based on the above, one or more embodiments the present disclosure may reduce frame drops during critical user actions like scroll, gaming, browsing, and several other use cases, to improve overall user experience while using a display device.

In an embodiment, one or more embodiments of the present disclosure may reduce frame drop of 120 Hz display devices by, for example, 35%. The one or more embodiments of the present disclosure may inject new frames from the application by scheduling draw calls on the application main thread whenever the current frame is janky so that the system framework component has more buffers to display in case of consecutive frame drops. Therefore, one or more embodiments of the present disclosure may significantly improve the scroll performance of a display device without affecting the Vsync pulse.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

While at least one exemplary embodiment has been presented in the foregoing detailed description, it should be appreciated that a vast number of variations exist.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method for frame processing in a display device during a scroll event, the method comprising:
determining a first processing time for generation of a first frame among a plurality of frames to be displayed on the display device;
detecting an ongoing delay in the first processing time for the first frame based on a predefined frame duration threshold;
determining whether a second frame is to be rendered on the display device subsequent to the ongoing delay based on one or more device parameters associated with the display device; and
generating the second frame during the ongoing delay based on the determination that the second frame is to be rendered on the display device.

2. The method of claim 1, further comprising:
updating a buffer with the generated second frame.

3. The method of claim 1, further comprising:
prior to the generating of the second frame, receiving an animation timeline depicting a display sequence of the plurality of frames;
determining a number of one or more buffer frames to be displayed on the display device;
identifying a frame duration of the first frame;
determining a refresh time stamp of the display device based on a refresh rate of the display device; and
updating the animation timeline by adding a new bias time based on the second frame and the determined refresh time stamp.

4. The method of claim 3, further comprising:
rendering the generated second frame on the display device subsequent to the ongoing delay based on the updated animation timeline.

5. The method of claim 4, wherein the rendering of the generated second frame on the display device comprises:
identifying a scroll distance based on the identified refresh time stamp with the added bias time; and
performing a scroll animation of the generated second frame based on the identified scroll distance.

6. The method of claim 1, further comprising:
determining one or more vacant spaces within a buffer based on the generation of the second frame, wherein the buffer includes one or more frames to be rendered on the display device;
generating one or more additional frames based on the one or more device parameters; and
updating the buffer with the one or more additional frames.

7. The method of claim 1, wherein the determining of the first processing time for generation of the first frame is based on one or more frame-related parameters, the one or more frame-related parameters comprising refresh interval, view creation timing, view data binding timing, thread sleep timing, or a texture upload time.

8. The method of claim 1, wherein the generating of the second frame comprises:
triggering an instruction signal to an application to generate the second frame based on the scroll event.

9. The method of claim 1, wherein the one or more device parameters include a battery level, a power saving mode configuration, a current display refresh rate, motion smoothness, multiwindow mode, device temperature, or an available memory of the display device.

10. A system for frame processing in a display device during a scroll event, the system comprising:
memory storing at least one instruction; and
at least one processor,
wherein the at least one instruction, when executed by the at least one processor individually or collectively, cause the system to:
determine a first processing time for generation of a first frame among a plurality of frames to be displayed on the display device;
detect an ongoing delay in the first processing time for the first frame based on a predefined frame duration threshold;
determine whether a second frame is to be rendered subsequent to the ongoing delay on the display device based on one or more device parameters associated with the display device; and
generate the second frame during the ongoing delay based on the determination that the second frame is to be rendered.

11. The system of claim 10, wherein the at least one instruction, when executed by the at least one processor individually or collectively, cause the system to:
update a buffer with the second frame to be rendered on the display device subsequent to the ongoing delay based on the generation of the second frame.

12. The system of claim 10, wherein the at least one instruction, when executed by the at least one processor individually or collectively, cause the system to:
prior to the generation of the second frame, receive an animation timeline depicting a display sequence of the plurality of frames;
determine a number of one or more buffer frames to be displayed on the display device;
identify a frame duration of the first frame;
determine a refresh time stamp of the display device based on a refresh rate of the display device; and
update the animation timeline by adding a new bias based on the second frame and the determined refresh time stamp.

13. The system of claim 12, wherein the at least one instruction, when executed by the at least one processor individually or collectively, cause the system to:
render the generated second frame on the display device subsequent to the ongoing delay based on the updated animation timeline.

14. The system of claim 13, wherein the at least one instruction to render the generated second frame on the display device subsequent to the ongoing delay, when executed by the at least one processor individually or collectively, further cause the system to:
identify a scroll distance based on the identified refresh time stamp with the added bias time; and
perform a scroll animation of the generated second frame based on the identified scroll distance.

15. A non-transitory computer-readable storage medium having stored thereon instructions that, when executed by at least one processor of a system individually or collectively, cause the system to:
identify an detected touch input in a display device as a scroll event;
determine a first processing time for generation of a first frame among a plurality of frames to be displayed on the display device;
detect an ongoing delay in the first processing time for the first frame based on a predefined frame duration threshold;
determine whether a second frame is to be rendered subsequent to the ongoing delay on the display device based on one or more device parameters associated with the display device; and
generate the second frame during the ongoing delay based on the determination that the second frame is to be rendered.

16. The non-transitory computer-readable storage medium of claim 15, wherein the instructions further comprise instructions that, when executed by the at least one processor individually or collectively, cause the system to:
update a buffer, with the second frame to be rendered on the display device subsequent to the ongoing delay based on the generation of the second frame.

17. The non-transitory computer-readable storage medium of claim 15, wherein the instructions further comprise instructions that, when executed by the at least one processor individually or collectively, cause the system to:
prior to the generation of the second frame, receive an animation timeline depicting a display sequence of the plurality of frames;
determine a number of one or more buffer frames to be displayed on the display device;
identify a frame duration of the first frame;
determine a refresh time stamp of the display device based on a refresh rate of the display device; and
update the animation timeline by adding a new bias based on the second frame and the determined refresh time stamp.

18. The non-transitory computer-readable storage medium of claim 17, wherein the instructions further comprise instructions that, when executed by the at least one processor individually or collectively, cause the system to:
render the generated second frame on the display device subsequent to the ongoing delay based on the updated animation timeline.

19. The non-transitory computer-readable storage medium of claim 18, wherein the instructions to render the generated second frame on the display device subsequent to the ongoing delay further comprise instructions that, when executed by the at least one processor individually or collectively, cause the system to:
identify a scroll distance based on the identified refresh time stamp with the added bias time; and
perform a scroll animation of the generated second frame based on the identified scroll distance.

20. The non-transitory computer-readable storage medium of claim 15, wherein the one or more device parameters include a battery level, a power saving mode configuration, a current display refresh rate, motion smoothness, multiwindow mode, device temperature, or an available memory of the display device.
